(19) United States
(12) Patent Application Publication
(10) Pub. No.: US 2024/0125933 A1
(43) Pub. Date: Apr. 18, 2024

(54) RANGING DEVICE

(71) Applicant: CANON KABUSHIKI KAISHA, Tokyo (JP)

(72) Inventor: MASASHI NIWA, Chiba (JP)

(21) Appl. No.: 18/483,534

(22) Filed: Oct. 10, 2023

(30) Foreign Application Priority Data
Oct. 18, 2022 (JP) 2022-166893

(51) Int. Cl. G01S 17/14; G01S 7/48; G01S 7/4861; G01S 7/4865; G01S 7/497; G01S 17/931

(52) U.S. Cl. CPC G01S 17/14; G01S 7/4808; G01S 7/4861; G01S 7/4865; G01S 7/497; G01S 17/931

(57) ABSTRACT

A ranging device includes: a pulse generation unit configured to generate a signal including a pulse based on incident light; a first decoder unit configured to generate a first frequency distribution having a first class width based on the time count value and the number of pulses; a second decoder unit configured to generate a second frequency distribution having a second class width narrower than the first class width based on the time count value and the number of pulses; a first ambient light information generation unit configured to generate first ambient light information based on the first frequency distribution; and a distance calculation unit configured to calculate distance information based on the second frequency distribution.

### BACKGROUND OF THE INVENTION

### Field of the Invention

The present disclosure relates to a ranging device.

### Description of the Related Art

Japanese Patent Application Laid-Open No. 2021-001763 discloses a ranging device that measures a distance to an object based on a time difference between a time at which light is irradiated and a time at which reflected light is received. The ranging device of Japanese Patent Application Laid-Open No. 2021-001763 calculates a distance from a frequency distribution of a count value of incident light with respect to time from light emission. In Japanese Patent Application Laid-Open No. 2021-001763, a first frequency distribution (histogram) is generated based on a count value counted at a first temporal resolution. Then, in a range of bins determined from the first frequency distribution, a second frequency distribution is generated based on a count value counted at a second temporal resolution, and a distance is calculated from the second frequency distribution. In this case, by setting the second temporal resolution higher than the first temporal resolution, the circuit area for storing the frequency distribution can be reduced.

Japanese Patent Application Laid-Open No. 2010-091377 discloses a method of calculating an average value of remaining bins excluding a bin indicating a maximal value of a frequency distribution for ranging as a disturbance light component.

However, in a method of using a plurality of frequency distributions with different temporal resolutions as in Japanese Patent Application Laid-Open No. 2021-001763, if a method of calculating ambient light information as in Japanese Patent Application Laid-Open No. 2010-091377 is applied, the accuracy of ambient light information may not be sufficiently obtained.

### SUMMARY OF THE INVENTION

It is an object of the present disclosure to provide a ranging device with improved accuracy in calculating ambient light information.

According to a disclosure of the present specification, there is provided a ranging device including: a time counting unit configured to generate a time count value; a pulse generation unit configured to generate a signal including a pulse based on incident light; a first decoder unit configured to generate a first frequency distribution having a first class width based on the time count value and the number of pulses; a first peak detection unit configured to determine first time information indicating a time corresponding to a first peak of the number of pulses based on the first frequency distribution; a second decoder unit configured to generate a second frequency distribution having a second class width narrower than the first class width based on the time count value and the number of pulses; a range determination unit configured to determine a range of the time count value at which the second frequency distribution is to be acquired based on the first time information; a first ambient light information generation unit configured to generate first ambient light information based on the first frequency distribution; and a distance calculation unit configured to calculate distance information based on the second frequency distribution.

Further features of the present invention will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a functional block diagram illustrating a schematic configuration example of the ranging device according to the first embodiment.

FIG. 3 is a diagram illustrating an outline of an operation of the ranging device in one ranging period according to the first embodiment.

FIGS. 4A, 4B, 4C, and 4D are histograms visually illustrating frequency distributions of pulse count values according to the first embodiment.

FIGS. 5A, 5B, and 5C are histograms for explaining an example of acquiring a frequency distribution with a plurality of resolutions according to the first embodiment.

FIG. 6 is a schematic diagram explaining an example of acquiring a frequency distribution based on a plurality of resolutions according to the first embodiment.

FIG. 7 is a flowchart explaining an operation of the ranging device according to the first embodiment.

FIG. 8 is a timing chart illustrating an operation of a first decoder unit according to the first embodiment.

FIG. 9 is a histogram illustrating an example of a low resolution frequency distribution and an ambient light value according to the first embodiment.

FIGS. 10A and 10B are histograms illustrating examples of the low resolution frequency distribution and the ambient light value according to the first embodiment.

FIG. 11 is a timing chart illustrating an operation of a second decoder unit according to the first embodiment.

FIG. 12 is a histogram illustrating an example of a high resolution frequency distribution and the ambient light value according to the first embodiment.

FIG. 13 is a histogram illustrating an example of a low resolution frequency distribution according to a second embodiment.

FIG. 14 is a functional block diagram illustrating a schematic configuration example of a ranging device according to the second embodiment.

FIG. 15 is a histogram illustrating an example of the low resolution frequency distribution and an ambient light value according to the second embodiment.

FIGS. 16A, 16B, and 16C are histograms illustrating examples of high resolution frequency distributions and ambient light values according to the second embodiment.

FIG. 17 is a schematic view illustrating an overall configuration of a photoelectric conversion device according to a fourth embodiment.

FIG. 18 is a schematic block diagram illustrating a configuration example of a sensor substrate according to the fourth embodiment.

FIG. 19 is a schematic block diagram illustrating a configuration example of a circuit substrate according to the fourth embodiment.

FIG. 20 is a schematic block diagram illustrating a configuration example of one pixel of a photoelectric conversion unit and a pixel signal processing unit according to the fourth embodiment.

FIGS. 21A, 21B, and 21C are diagrams illustrating an operation of an avalanche photodiode according to the fourth embodiment.

FIGS. 22A and 22B are schematic diagrams of equipment according to a fifth embodiment.

### DESCRIPTION OF THE EMBODIMENTS

Preferred embodiments of the present invention will now be described in detail in accordance with the accompanying drawings. In the drawings, the same or corresponding elements are denoted by the same reference numerals, and the description thereof may be omitted or simplified.

### First Embodiment

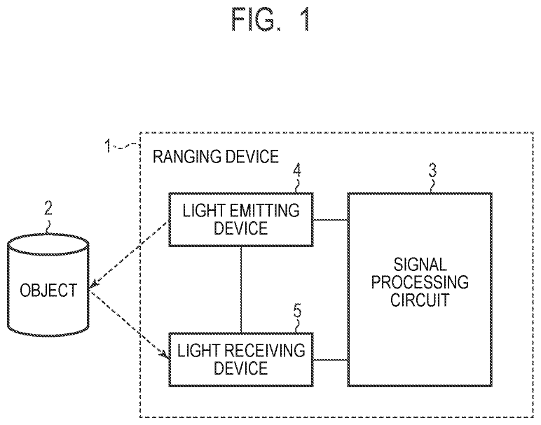

FIG. 1 is a hardware block diagram illustrating a schematic configuration example of a ranging device 1 according to the present embodiment. The ranging device 1 includes a signal processing circuit 3, a light emitting device 4, and a light receiving device 5. Note that the configuration of the ranging device 1 illustrated in the present embodiment is an example, and is not limited to the illustrated configuration.

The ranging device 1 is a device for measuring a distance to an object 2 for the ranging using a technology such as light detection and ranging (LiDAR). The ranging device 1 measures the distance from the ranging device 1 to the object 2 based on a time difference until light emitted from the light emitting device 4 is reflected by the object 2 and received by the light receiving device 5. Further, the ranging device 1 can measure distances at a plurality of points in a two-dimensional manner by emitting laser light to a predetermined distance measuring area including the object 2 and receiving reflected light by a pixel array. Thus, the ranging device 1 can generate and output a distance image. Such a scheme is sometimes referred to as flash LiDAR.

The light received by the light receiving device 5 includes ambient light such as sunlight in addition to the reflected light from the object 2. For this reason, the ranging device 1 measures incident light in each of a plurality of periods (bin periods), and performs distance measurement in which influence of ambient light is reduced by using a method of determining that reflected light is incident in a period in which the amount of light peaks. Further, the ranging device 1 of the present embodiment outputs reliability information, which is an index relating to ranging accuracy affected by noise such as ambient light, to an external device. Thus, the external device can acquire the reliability information in addition to distance information, and the reliability information can be utilized for information processing using the distance information. Therefore, the accuracy of the information processing of the entire system including the ranging device 1 can be improved.

The light emitting device 4 emits light such as laser light to the outside of the ranging device 1. When the ranging device 1 is the flash LiDAR, the light emitting device 4 may be a surface light source such as a surface emitting laser. The signal processing circuit 3 may include a control circuit, a counter circuit, a processor that performs arithmetic processing of digital signals, a memory that stores digital signals, and the like. The memory may be, for example, a semiconductor memory.

The light receiving device 5 generates a pulse signal including a pulse based on the incident light. The light receiving device 5 is, for example, a photoelectric conversion device including an avalanche photodiode as a photoelectric conversion element. In this case, when one photon is incident on the avalanche photodiode and a charge is generated, one pulse is generated by avalanche multiplication. However, the light receiving device 5 may include, for example, a photoelectric conversion element using another photodiode. The light receiving device 5 includes a plurality of photoelectric conversion elements, and can output a signal indicating an address of a photoelectric conversion element into which a photon is incident.

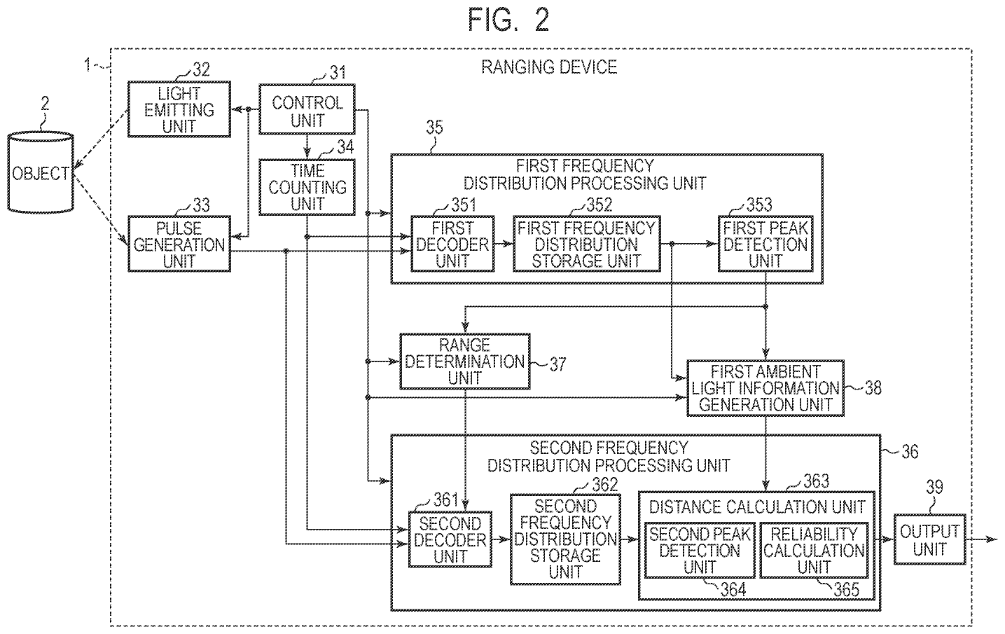

FIG. 2 is a functional block diagram illustrating a schematic configuration example of the ranging device 1 according to the present embodiment. The ranging device 1 includes a control unit 31, a light emitting unit 32, a pulse generation unit 33, a time counting unit 34, a first frequency distribution processing unit 35, a second frequency distribution processing unit 36, a range determination unit 37, a first ambient light information generation unit 38, and an output unit 39. The first frequency distribution processing unit 35 includes a first decoder unit 351, a first frequency distribution storage unit 352, and a first peak detection unit 353. The second frequency distribution processing unit 36 includes a second decoder unit 361, a second frequency distribution storage unit 362, and a distance calculation unit 363. The distance calculation unit 363 includes a second peak detection unit 364 and a reliability calculation unit 365. The light emitting unit 32 and the pulse generation unit 33 correspond to the light emitting device 4 and the light receiving device 5 in FIG. 1, respectively. The control unit 31, the time counting unit 34, the first frequency distribution processing unit 35, the second frequency distribution processing unit 36, the range determination unit 37, the first ambient light information generation unit 38, and the output unit 39 correspond to the signal processing circuit 3 in FIG. 1.

The control unit 31 controls the start of light emission and time counting a plurality of times within one frame period. The control unit 31 is a control circuit that outputs a control signal indicating an operation timing, an operation condition, and the like of each unit of the ranging device 1 to the light emitting unit 32, the pulse generation unit 33, the time counting unit 34, the first frequency distribution processing unit 35, the second frequency distribution processing unit 36, the range determination unit 37, and the first ambient light information generation unit 38. Thus, the control unit 31 controls these units.

The light emitted from the light emitting unit 32 is reflected by the object 2. The light including the reflected light from the object 2 is incident on the pulse generation unit 33. The pulse generation unit 33 converts the light into a pulse signal and outputs the pulse signal to the first decoder unit 351 and the second decoder unit 361.

The time counting unit 34 performs time counting based on the control of the control unit 31, and acquires an elapsed time from the time at which counting is started as a digital signal. The control unit 31 synchronously controls a timing at which the light emitting unit 32 emits light and a timing at which the time counting unit 34 starts time counting. Thus, the time counting unit 34 can count the elapsed time from the light emission by the light emitting unit 32. The time counting unit 34 includes, for example, a circuit such as a ring oscillator and a counter, and counts a clock pulse that vibrates at high speed and at a constant period, thereby performing time counting.

The first decoder unit 351 performs memory control to update a value of corresponding memory address of the first frequency distribution storage unit 352 based on the pulse signal output from the pulse generation unit 33 and a time count value at a timing at which the pulse is emitted.

The first frequency distribution storage unit 352 is a memory that stores the number of pulses that are input, that is, the number of photons detected by the pulse generation unit 33 (pulse count value) for each time interval that has been set. Since each of the plurality of time intervals corresponds to one interval of a histogram of the number of photons, it may be referred to as a bin.

The time range in the frequency distribution stored in the first frequency distribution storage unit 352 under the control of the first decoder unit 351 is set so as to cover the entire range in which ranging can be performed. The time interval of the frequency distribution stored in the first frequency distribution storage unit 352 is set to be larger than the ranging accuracy of the ranging device 1. That is, the first frequency distribution storage unit 352 stores a frequency distribution with low temporal resolution. This frequency distribution may be referred to as a low resolution frequency distribution or a first frequency distribution.

The first peak detection unit 353 calculates peak time information (first time information) indicating a time at a peak (first peak) of the pulse count values from the data of the frequency distribution stored in the first frequency distribution storage unit 352. The number of peaks may be one or more.

The range determination unit 37 determines a time range of frequency distribution acquisition in the second decoder unit 361 based on the peak time information calculated in the first peak detection unit 353, and outputs the time range to the second decoder unit 361.

The first ambient light information generation unit 38 generates ambient light information (first ambient light information) based on the frequency distribution stored in the first frequency distribution storage unit 352 and the peak time information calculated by the first peak detection unit 353.

The pulse signal output from the pulse generation unit 33, the time count value at the timing at which the pulse is emitted, and the time range output from the range determination unit 37 are input to the second decoder unit 361. The second decoder unit 361 performs memory control to update the value of the corresponding memory address of the second frequency distribution storage unit 362 based on these signals.

The second frequency distribution storage unit 362 is a memory that stores the number of pulses that are input, that is, the number of photons detected by the pulse generation unit 33 (pulse count value) for each time interval that has been set.

The time range in the frequency distribution stored in the second frequency distribution storage unit 362 under the control of the second decoder unit 361 is set by the range determination unit 37. The time interval of the frequency distribution stored in the second frequency distribution storage unit 362 is set in accordance with the ranging accuracy of the ranging device 1. That is, the second frequency distribution storage unit 362 stores a frequency distribution having a higher temporal resolution than the frequency distribution stored in the first frequency distribution storage unit 352. This frequency distribution may be referred to as a high resolution frequency distribution or a second frequency distribution. In other words, when the class width of the low resolution frequency distribution stored in the first frequency distribution storage unit 352 is the first class width and the class width of the high resolution frequency distribution stored in the second frequency distribution storage unit 362 is the second class width, the second class width is narrower than the first class width.

The second peak detection unit 364 calculates peak time information (second time information) indicating a time at a peak (second peak) of the pulse count values based on the frequency distribution stored in the second frequency distribution storage unit 362. The number of peaks may be one or more.

The reliability calculation unit 365 calculates the reliability information corresponding to the time information at the peak based on the frequency distribution stored in the second frequency distribution storage unit 362, the ambient light information, and the peak time information calculated by the second peak detection unit 364. The reliability information is information indicating reliability of ranging. For example, the reliability information may be a numerical value relating to a possibility that the object 2 is actually present at a distance corresponding to the detected peak time information, or may be a determination result indicating whether or not the object 2 can be detected. The reliability information may include a plurality of pieces of data of those.

The distance calculation unit 363 outputs the distance information based on the peak time information and the reliability information thereof to the output unit 39. The output unit 39 outputs the distance information and the reliability information to an external device of the ranging device 1. The output unit 39 may output peak time information corresponding to one peak as distance information, or may output peak time information corresponding to a plurality of peaks as distance information.

When the ranging device 1 is the flash LiDAR, although not illustrated in FIG. 2, the pulse generation unit 33 may be arranged as a pixel array forming a plurality of rows and a plurality of columns. In this case, a plurality of sets of the first frequency distribution processing unit 35, the second frequency distribution processing unit 36, the range determination unit 37, and the first ambient light information generation unit 38 are arranged so as to correspond to the plurality of pulse generation units 33, respectively.

The first frequency distribution processing unit 35, the second frequency distribution processing unit 36, the range determination unit 37, and the first ambient light information generation unit 38 will be described in more detail later.

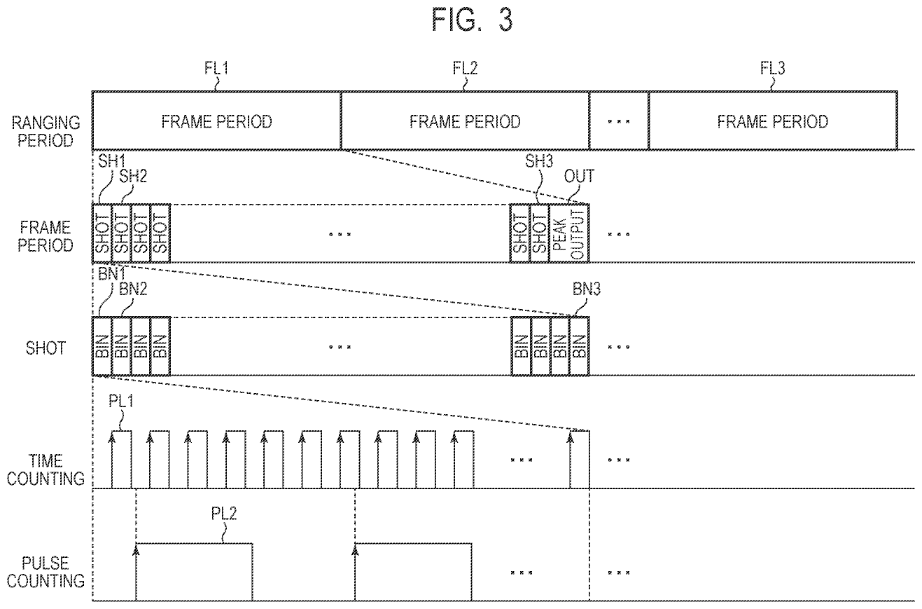

FIG. 3 is a diagram illustrating an outline of the operation of the ranging device 1 according to the present embodiment in one ranging period. In the description of FIG. 3, it is assumed that the ranging device 1 is the flash LiDAR. In the “ranging period” of FIG. 3, a plurality of frame periods FL1, FL2, . . . FL3 included in one ranging period are illustrated. The frame period FL1 indicates a first frame period in one ranging period, the frame period FL2 indicates a second frame period in one ranging period, and the frame period FL3 indicates a last frame period in one ranging period. The frame period is a period in which the ranging device 1 performs one ranging and outputs one signal indicating a distance (ranging result) from the ranging device 1 to the object 2 to the outside.

In the “frame period” of FIG. 3, a plurality of shots SH1, SH2, . . . , SH3 included in the frame period FL1 and a peak output OUT are illustrated. The shot is a period in which the light emitting unit 32 emits light once and the frequency distribution stored in the first frequency distribution storage unit 352 and the second frequency distribution storage unit 362 is updated by a pulse count value based on the light emission. The shot SH1 indicates a first shot in the frame period FL1. The shot SH2 indicates a second shot in the frame period FL1. The shot SH3 indicates a last shot in the frame period FL1. The peak output OUT indicates a period during which a ranging result is output based on a peak acquired by accumulating signals of a plurality of shots.

In the “shot” of FIG. 3, a plurality of bins BN1, BN2, . . . , BN3 included in the shot SH1 are illustrated. The “bin” indicates one time interval during which a series of pulse counting is performed, and is a period during which the first decoder unit 351 and the second decoder unit 361 perform pulse counting to acquire a pulse count value. The bin BN1 indicates a first bin in the shot SH1. The bin BN2 indicates a second bin in the shot SH1. The bin BN3 indicates a last bin in the shot SH1.

The “time counting” in FIG. 3 schematically illustrates a pulse PL1 used for time counting in the time counting unit 34 in the bin BN1. As illustrated in FIG. 3, the time counting unit 34 generates a time count value by counting the pulse PL1 that rises periodically. When the time count value reaches a predetermined value, the bin BN1 ends, and the process transitions to the next bin BN2.

The “pulse counting” in FIG. 3 schematically illustrates pulses based on incident light output from the pulse generation unit 33 in the bin BN1 and counted in the first decoder unit 351 and the second decoder unit 361. When one photon is incident on the pulse generation unit 33, one pulse PL2 rises. In the example of FIG. 3, two pulses rise in the period of the bin BN1, and “2” is acquired as the pulse count value of the bin BN1. Similarly, pulse count values are sequentially acquired in similar manner for the bin BN2 and after the bin BN2. As illustrated in FIG. 3, the frequency of the pulse PL1 of the time counting is set sufficiently higher than the frequency of the rising edge of the pulse PL2 of the pulse counting. In this case, the number of pulses PL2 can be appropriately counted.

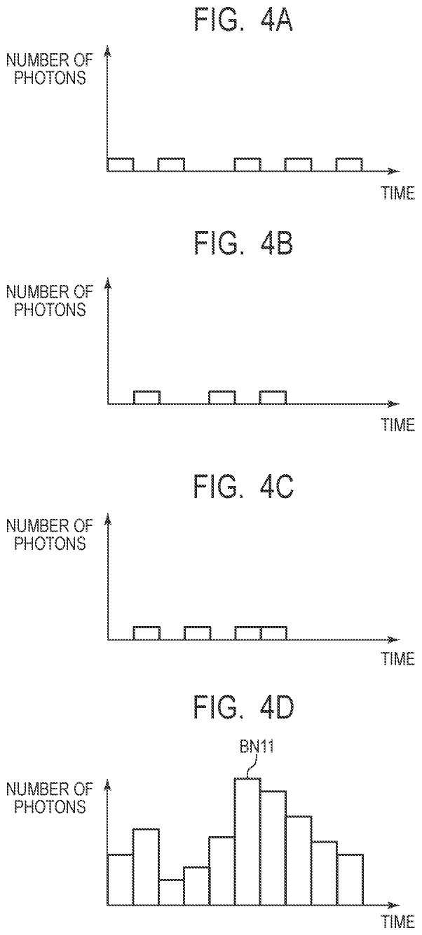

FIGS. 4A to 4D are histograms visually illustrating frequency distributions of pulse count values counted by the first decoder unit 351 and the second decoder unit 361. In this specification, the frequency distribution is frequency information corresponding to a predetermined class width, and is not necessarily displayed visually. FIGS. 4A, 4B, and 4C illustrate examples of histograms of the numbers of photons (corresponding to pulse count values) in the first shot, the second shot, and the third shot, respectively. FIG. 4D illustrates an example of a histogram acquired by integrating the number of photons of all shots. The horizontal axis represents the elapsed time from light emission. An interval of the histogram corresponds to a period of one bin in which photon detection is performed. The vertical axis represents the number of photons detected in each bin period. Thus, the histogram includes first information (horizontal axis) on time and second information (vertical axis) on the number of pulses. Specifically, the first information includes, for example, the start time of the time interval of the bin, and the end time of the time interval of the bin, the width (resolution) of the time interval of the bin, and the like. On the other hand, the second information is, for example, the number of pulses detected within the time interval of each bin. Similarly, the frequency distribution also includes first information on time and second information on the number of pulses.

As illustrated in FIG. 4A, in the first shot, five photons are incident on the pulse generation unit 33 at different times. As illustrated in FIG. 4B, in the second shot, three photons are incident on the pulse generation unit 33 at different times. As illustrated in FIG. 4C, in the third shot, four photons are incident on the pulse generation unit 33 at different times. Thus, the number of incident photons and the incident time are different in each shot. This is due to a pulse count value from ambient light other than reflected light from the object 2.

As illustrated in FIG. 4D, in the histogram obtained by integrating the number of photons of all shots, the sixth bin BN11 is a peak. In the peak output OUT illustrated in FIG. 3, time information of the bin corresponding to the peak of the integrated frequency distribution is output. The distance between the ranging device 1 and the object 2 can be calculated from the time information.

By accumulating the pulse count values of a plurality of shots, it is possible to detect a bin having a high possibility of reflected light from the object 2 more accurately even when pulse count by ambient light is included as in FIGS. 4A, 4B, and 4C. Therefore, even when the light emitted from the light emitting unit 32 is weak, the ranging can be performed with high accuracy by employing a process in which a plurality of shots are repeated and accumulating the pulse count values.

The ranging device 1 of the present embodiment acquires a frequency distribution based on two temporal resolutions of high resolution and low resolution. Further, the ranging device 1 of the present embodiment performs processing of determining the acquisition start time of the frequency distribution from the peak time information. The outline of the processing will be described below.

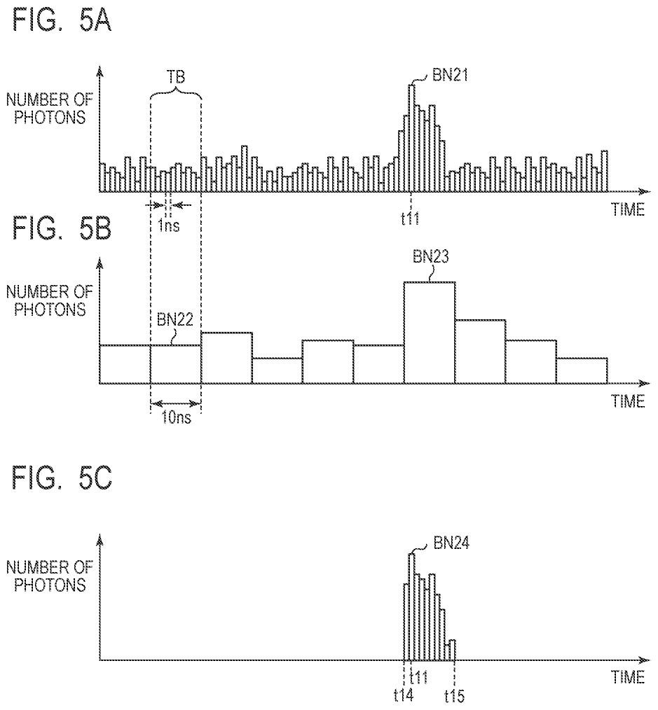

FIGS. 5A to 5C are histograms for explaining an example of acquiring a frequency distribution with a plurality of resolutions according to the present embodiment. FIG. 5A illustrates an example of a histogram based on bins with short time intervals, that is, high resolution bins, in all time ranges corresponding to distance ranges in which ranging is possible. FIG. 5A is not a histogram of the frequency distribution generated in the present embodiment, but is illustrated as a comparative example for explanation. When the resolution of the bin is increased, the detection time interval of the reflected light becomes finer, so that the distance resolution in the ranging is improved. In the example of FIG. 5A, the time interval of one bin is set to 1 ns, and the distance resolution is 15 cm. Since the number of bins is 100, the distance at which the distance can be measured is 15 m at the maximum. For example, when the number of shots in one frame period is 1000, a storage capacity of 10 bits is required for one bin of one pixel. Therefore, in the case where the light receiving element of the ranging device 1 has a large number of pixels and ranging can be performed far from the ranging device 30, a large amount of storage capacity is required, and the storage capacity may not fall within a practical amount of storage capacity. In the example of FIG. 5A, the bin BN21 at time t11 is a peak.

FIG. 5B is an example of resolution setting in the present embodiment, and is an example of a histogram that can be generated by the first frequency distribution processing unit 35 in which low resolution bins are set. In the example of FIG. 5B, the time interval of one bin is set to 10 ns, and the number of bins is 10. The storage of such a frequency distribution is realized by a storage capacity of 15 bits per bin for one pixel. The sum of the number of photons of the ten bins included in the period TB of FIG. 5A corresponds to the number of photons of one bin BN22 of the period TB of FIG. 5B.

FIG. 5C is an example of resolution setting in the present embodiment, and is an example of a histogram that can be generated by the second frequency distribution processing unit 36 in which high resolution bins are set. In the example of FIG. 5C, the time interval of one bin is set to 1 ns as in the example of FIG. 5A. In addition, the number of bins is 10. The storage of such a frequency distribution is realized by a storage capacity of 10 bits per bin for one pixel. In the example of FIG. 5C, the peak bin BN23 is extracted from the frequency distribution acquired in the low resolution bin setting of FIG. 5B. Then, the frequency distribution is acquired with the high resolution bin setting within a time interval corresponding to the BN23. In FIG. 5C, time t14 is the acquisition start time of the frequency distribution, and time t15 is the acquisition end time of the frequency distribution. These times are set so as to coincide with the period of the peak bin BN23. By performing the setting as illustrated in FIG. 5C, the bin BN24 at the time t11 can be detected as a peak as in the case of FIG. 5A. Further, the number of bins can be reduced as compared with the example of FIG. 5A, and the necessary storage capacity is reduced.

Thus, although a large storage capacity is required for one bin of low resolution bins, the total number of bins that is sum of the number of bins with low resolution and the number of bins with high resolution is reduced. Therefore, in the present embodiment, the storage capacity is reduced as compared with the case where the frequency distribution is acquired with the high resolution bins in all the time ranges as illustrated in FIG. 5A. Note that the configuration of the bins which can be applied in the present embodiment is not limited to the configurations exemplified including the examples described later. The configuration of the bins can be determined by comprehensively considering the maximum distance that can be measured, the required distance resolution, the circuit scale of the ranging device 1, and the like.

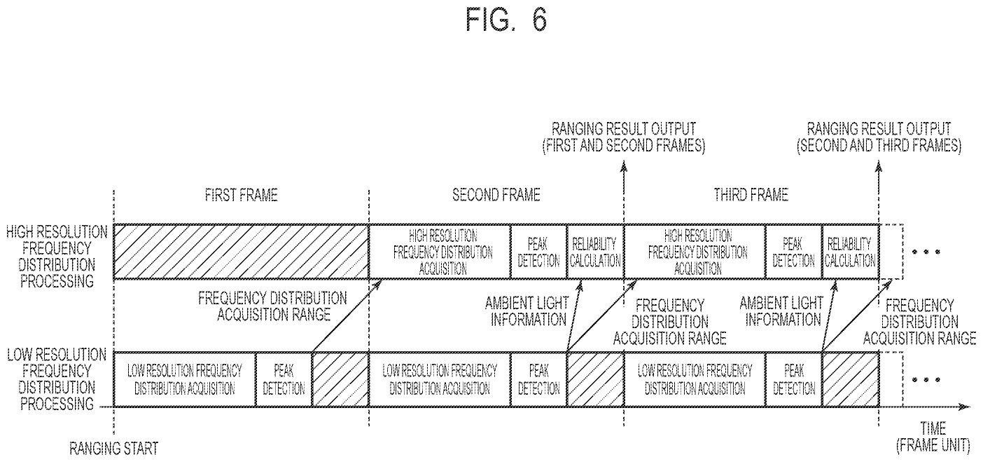

FIG. 6 is a schematic diagram explaining an example of acquiring a frequency distribution based on a plurality of resolutions according to the present embodiment. FIG. 6 illustrates an outline of processing performed by the first frequency distribution processing unit 35 and the second frequency distribution processing unit 36 during a period from the first frame to the third frame. In FIG. 6, the “high resolution frequency distribution processing” represents processing performed in the second frequency distribution processing unit 36, and the “low resolution frequency distribution processing” represents processing performed in the first frequency distribution processing unit 35.

In the first frame immediately after the start of ranging, the first decoder unit 351 and the first frequency distribution storage unit 352 acquire a low resolution frequency distribution. Then, the first peak detection unit 353 performs peak detection from the acquired low resolution frequency distribution. The range determination unit 37 determines an acquisition range of the high resolution frequency distribution in the second frame next to the first frame and outputs the acquisition range to the second decoder unit 361. In the first frame, since the acquisition range of the high resolution frequency distribution is not determined, the high resolution frequency distribution is not acquired. The hatched blocks in FIG. 6 indicate periods during which processing is not performed.

In the second frame, the first frequency distribution processing unit 35 acquires a low resolution frequency distribution and detects a peak similarly to the first frame. The range determination unit 37 determines an acquisition range of the high resolution frequency distribution in the third frame next to the second frame and outputs the acquisition range to the second decoder unit 361. The first ambient light information generation unit 38 generates ambient light information of the second frame and outputs the ambient light information to the distance calculation unit 363.

In the second frame, the second frequency distribution processing unit 36 acquires a high resolution frequency distribution, detects a peak, and calculates reliability information. The acquisition range output from the range determination unit 37 in the first frame is used to set the acquisition range of the high resolution frequency distribution. The ambient light information output from the first ambient light information generation unit 38 in the second frame is used to calculate the reliability information.

In the second frame, the processing of the first frequency distribution processing unit 35 and the processing of the second frequency distribution processing unit 36 are performed in parallel. After the completion of the processing, the output unit 39 outputs the distance information and the reliability information as the ranging results of the first frame and the second frame. Since the processing in the third frame and after the third frame is the same as that of the second frame, the description thereof will be omitted.

Although the present embodiment illustrates an example in which frequency distributions are acquired with two kinds of resolutions of high resolution and low resolution, the present embodiment is not limited thereto. For example, frequency distributions with three or more kinds of resolutions may be acquired. As an example, a case where three frequency distribution processing units corresponding to three kinds of resolutions of the first resolution, the second resolution, and the third resolution are arranged will be described. First, in the first frame, a frequency distribution of the first resolution is acquired. In the next second frame, a frequency distribution of the second resolution is acquired for bins in a range determined based on the frequency distribution of the first resolution. In the next third frame, a frequency distribution of the third resolution is acquired for bins in a range determined based on the frequency distribution of the second resolution. Then, in the next fourth frame, a frequency distribution of the first resolution is acquired for the bins in a range determined based on the frequency distribution of the third resolution. Similarly, the acquisition ranges of the three types of bins of the first resolution, the second resolution, and the third resolution are sequentially switched. From the viewpoint of reducing the number of bins in which the frequency distributions are acquired, it is desirable that the second resolution be higher than the first resolution and the third resolution be higher than the second resolution. For example, the time intervals of bins in the first resolution, the second resolution, and the third resolution may be set as 100 ns, 10 ns, and 1 ns, respectively. The method capable of acquiring the frequency distributions based on three or more kinds of resolution is applicable not only to the present embodiment but also to other embodiments described later.

FIG. 6 illustrates an example in which the low resolution frequency distribution processing and the high resolution frequency distribution processing are performed in parallel, but the timings of the low resolution frequency distribution processing and the high resolution frequency distribution processing are not limited thereto. The low resolution frequency distribution processing and the high resolution frequency distribution processing may be performed sequentially.

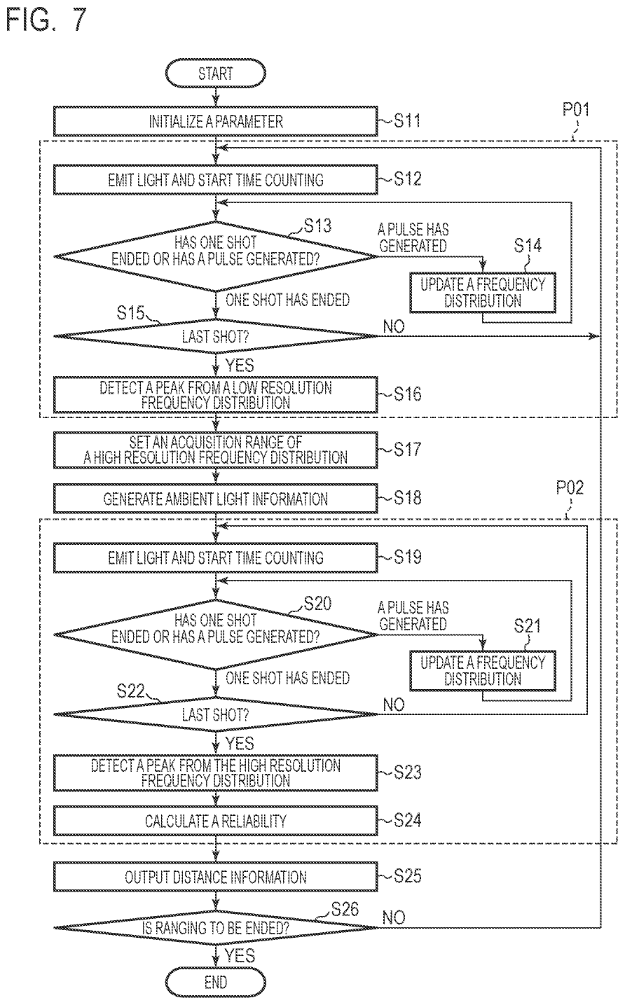

Next, a specific processing flow for realizing the above-described processing and contents of the processing of each block will be described with reference to a flowchart of FIG. 7. FIG. 7 is a flowchart explaining an operation of the ranging device 1 according to the present embodiment. FIG. 7 illustrates an operation from the start to the end of the ranging period. In FIG. 7, a low resolution frequency distribution processing P01 of a certain frame and a high resolution frequency distribution processing P02 of the next frame are extracted, but actually, the low resolution frequency distribution processing and the high resolution frequency distribution processing may be performed in parallel as illustrated in FIG. 6.

In step S11 immediately after the start of distance measurement, the control unit 31 outputs a control signal for initializing a parameter for ranging to the first frequency distribution processing unit 35, the second frequency distribution processing unit 36, the range determination unit 37, and the first ambient light information generation unit 38.

The low resolution frequency distribution processing P01 includes steps S12 to S16. A loop of the step S12, the step S13, and the step S14 after the step S11 indicates processing in which signal acquisition of one shot is performed. A loop from the step S12 to the step S15 indicates processing in which a low resolution frequency distribution of one frame is acquired.

In the step S12, the light emitting unit 32 emits light to the ranging area. At the same time, the time counting unit 34 starts time counting. Thereby, the signal acquisition processing of one shot is started. The control unit 31 controls the light emission of the light emitting unit 32 and the start of counting by the time counting unit 34 so as to be synchronized with each other. Thus, the elapsed time from the light emission can be counted.

In the step S13, when the first decoder unit 351 detects generation of a pulse due to incident light from the pulse signal output from the pulse generation unit 33 (“a pulse has generated” in the step S13), the process proceeds to the step S14. When the control unit 31 detects that the processing time of one shot has elapsed in the step S13 (“one shot has ended” in the step S13), the process proceeds to the step S15.

In the step S14, the first decoder unit 351 updates a frequency distribution stored in the first frequency distribution storage unit 352 based on the time count value at a timing at which the pulse is detected and the parameter set in the step S11. The update processing may be processing of incrementing a pulse count value of a bin corresponding to a time count value at a timing at which a pulse is detected. After updating the frequency distribution, the process returns to the step S13. By the loop of the steps S13 and S14, pulse count values of bins in one shot are sequentially acquired, and the frequency distribution is generated.

In the step S15, the control unit 31 determines whether or not the shot finished in the step S13 is the last shot, that is, whether or not signal acquisition of a predetermined number of shots is completed. When it is determined that the signal acquisition of the predetermined number of shots has not been completed (NO in the step S15), the process proceeds to the step S12, where the signal acquisition of the next shot is started, and the same process is repeated. When it is determined that the signal acquisition of the predetermined number of shots has been completed (YES in the step S15), the process proceeds to the step S16.

In the step S16, the first peak detection unit 353 detects a peak from the low resolution frequency distribution. In step S17, the range determination unit 37 determines the acquisition range in the acquisition of the high resolution frequency distribution in the next frame period based on the peak detected from the low resolution frequency distribution. In step S18, the first ambient light information generation unit 38 generates ambient light information based on the low resolution frequency distribution and peak time information thereof.

The high resolution frequency distribution processing P02 in the next frame period of the low resolution frequency distribution processing P01 includes steps S19 to S24. A loop of the step S19, the step S20, and the step S21 indicates processing in which signal acquisition of one shot is performed. A loop from the step S19 to the step S22 indicates processing in which a high resolution frequency distribution of one frame is acquired.

In the step S19, the light emitting unit 32 emits light to the ranging area. At the same time, the time counting unit 34 starts time counting. Thereby, the signal acquisition processing of one shot is started. The control unit 31 controls the light emission of the light emitting unit 32 and the start of counting by the time counting unit 34 so as to be synchronized with each other. Thus, the elapsed time from the light emission can be counted.

In the step S20, when the second decoder unit 361 detects generation of a pulse due to incident light from the pulse signal output from the pulse generation unit 33 (“a pulse has generated” in the step S20), the process proceeds to the step S21. When the control unit 31 detects that the processing time of one shot has elapsed in the step S20 (“one shot has ended” in the step S20), the process proceeds to the step S22.

In the step S21, the second decoder unit 361 updates a frequency distribution stored in the second frequency distribution storage unit 362 based on the time count value at a timing at which a pulse is detected and the acquisition range set in the step S17. The update processing may be processing of incrementing a pulse count value of a bin corresponding to a time count value at a timing at which a pulse is detected. After updating the frequency distribution, the process returns to the step S20. By the loop of steps S20 and S21, pulse count values of bins in one shot are sequentially acquired, and the frequency distribution is generated.

In the step S22, the control unit 31 determines whether or not the shot finished in the step S20 is the last shot, that is, whether or not signal acquisition of a predetermined number of shots is completed. When it is determined that the signal acquisition of the predetermined number of shots has not been completed (NO in the step S22), the process proceeds to the step S19, the signal acquisition of the next shot is started, and the same process is repeated. When it is determined that the signal acquisition of the predetermined number of shots has been completed (YES in the step S22), the process proceeds to the step S23.

In the step S23, the second peak detection unit 364 detects a peak from the high resolution frequency distribution. In the step S24, the reliability calculation unit 365 calculates reliability information based on the peak value of the high resolution frequency distribution and the ambient light information. Then, in step S25, the output unit 39 outputs the distance information based on the peak time information and the reliability information to an external device of the ranging device 1 as a ranging result.

In step S26, the control unit 31 determines whether or not to end the ranging in the ranging device 1. When it is determined that the ranging is to be ended (YES in the step S26), the process ends. When it is determined that the ranging is not to be ended (NO in the step S26), the process proceeds to the step S12. This determination may be based on, for example, a control signal or the like from equipment on which the ranging device 1 is mounted.

Next, the operation of the first decoder unit 351 will be described in detail. The first decoder unit 351 receives a signal indicating the start of the frame period from the control unit 31 and starts the operation.

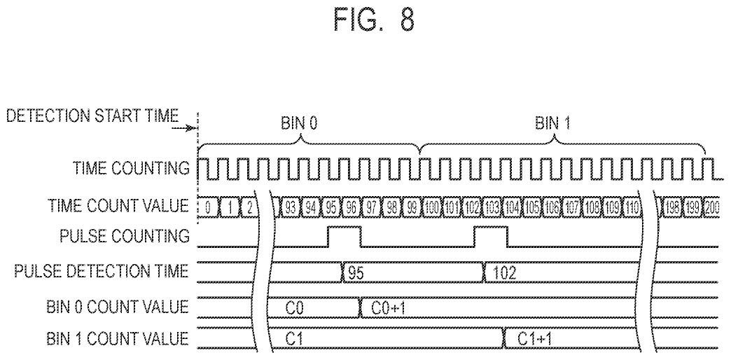

FIG. 8 is a timing chart illustrating the operation of the first decoder unit 351 according to the present embodiment. The “time counting” and the “pulse counting” in FIG. 8 are similar to those in FIG. 3. The “time count value” in FIG. 8 indicates an elapsed time from the start of the frame period. Pulses illustrated in “pulse counting” indicate the timings of photon incidence. The “pulse detection time”, “bin 0 count value”, and “bin 1 count value” in FIG. 8 indicate digital values related to the storage of the frequency distribution in the first frequency distribution storage unit 352 and the update timings of the digital values. Here, “bin 0” is the first bin among the plurality of bins, and “bin 1” is the second bin among the plurality of bins.

The initial value of the time count value is “0”, and the time count value is incremented each time the first decoder unit 351 detects the rising edge of the clock of the time counting. The “pulse count” indicates two pulses generated by photons entering the pulse generation unit 33. The first decoder unit 351 latches a time count value at a timing at which a pulse corresponding to a photon rises and holds it as a pulse detection time. The first decoder unit 351 determines a memory address for updating the frequency distribution based on the held pulse detection time, and updates the value of the address.

FIG. 8 illustrates an example in which the time when the time count value is “0” is the start time of frequency distribution acquisition. In this example, when a photon is incident and a pulse rises in the pulse counting during a period in which the count value is “0” to “99”, the count value of “bin 0” is updated. When a photon is incident and a pulse rises in the pulse counting during a period in which the count value is “100” to “199”, the count value of “bin 1” is updated. The first decoder unit 351 updates the value of “bin 0” from “C0” to “C0+1” in accordance with the pulse inputted at the time when the count value is “95”. Further, the first decoder unit 351 updates the value of “bin 1” from “C1” to “C1+1” in accordance with the pulse inputted at the time when the count value is “102”.

The first peak detection unit 353 receives a control signal indicating the completion of acquisition of the frequency distribution of one frame from the control unit 31, and starts the peak detection operation. The first peak detection unit 353 outputs the peak time information to the range determination unit 37.

In the above description, the peak time information generated by the first peak detection unit 353 is information indicating a bin having the largest value in the frequency distribution, but the peak time information is not limited thereto. The peak time information may be information indicating a plurality of bins having a value larger than a predetermined value in the frequency distribution, or may be information indicating a plurality of bins including bins before and after the bin having the largest value.

The range determination unit 37 receives a control signal indicating the start timing of the frame period from the control unit 31 and starts the operation. Further, the range determination unit 37 receives the peak time information from the first peak detection unit 353, determines the acquisition start time and the acquisition end time of the high resolution frequency distribution, and outputs them to the second decoder unit 361.

The first ambient light information generation unit 38 receives a control signal indicating the start timing of the frame period from the control unit 31 and starts operation. Further, the first ambient light information generation unit 38 receives the low resolution frequency distribution in the first frequency distribution storage unit 352 and the peak time information from the first peak detection unit 353, generates ambient light information, and outputs the ambient light information to the distance calculation unit 363.

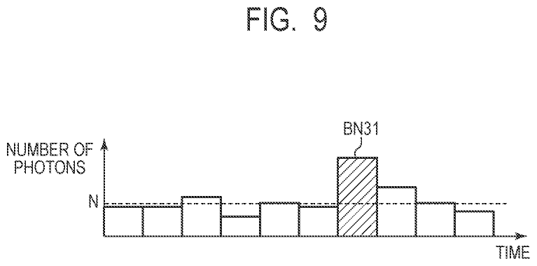

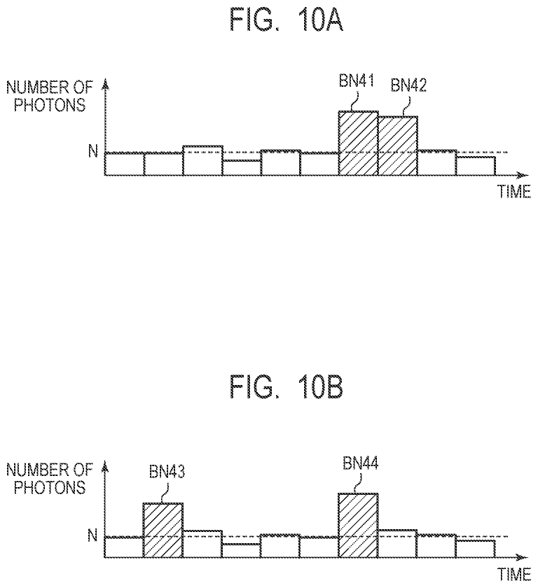

Hereinafter, with reference to FIGS. 9, 10A, and 10B, an example of a method of generating ambient light information from the low resolution frequency distribution will be described. FIGS. 9, 10A, and 10B are histograms illustrating examples of low resolution frequency distributions and ambient light values according to the present embodiment.

In the histogram illustrated in FIG. 9, one bin BN31 having the largest pulse count value is hatched. In the example of FIG. 9, the first ambient light information generation unit 38 calculates an average value of pulse count values of a plurality of bins except for the bin BN31 (nine bins in FIG. 9) as the ambient light value N. The bin BN31 is a peak of the plurality of bins, and is likely to include a pulse count value based on reflected light. Therefore, an appropriate ambient light value N excluding the influence of the reflected light can be calculated.

In the histogram illustrated in FIG. 10A, bins BN41 and BN42 having upper two pulse count values are hatched. Similarly, in the histogram illustrated in FIG. 10B, bins BN43 and BN44 having upper two pulse count values are hatched. In the examples of FIGS. 10A and 10B, the first ambient light information generation unit 38 calculates an average value of the pulse count values of a plurality of bins except for the two bins having upper two pulse count values as the ambient light value N.

In the example of FIG. 10A, the upper two bins BN41 and BN42 are adjacent to each other. Such a frequency distribution is likely to be obtained when the object 2 is positioned at a distance corresponding to the vicinity of the boundary of the low resolution bin. Since both bins BN41 and BN42 include pulse count values due to reflected light, an appropriate ambient light value N can be calculated by calculating an average value excluding both bins BN41 and BN42.

In the example of FIG. 10B, the upper two bins BN43 and BN44 are separated from each other. Such a frequency distribution is likely to be obtained when reflected light from a plurality of objects 2 at different distances can enter one pixel. Since both bins BN43 and BN44 include pulse count values due to reflected light, an appropriate ambient light value N can be calculated by calculating an average value excluding both bins BN43 and BN44.

As described above, the first ambient light information generation unit 38 calculates an average value of count values of a plurality of bins excluding at least one predetermined number of upper bins as the ambient light value N. However, the processing in the first ambient light information generation unit 38 is not limited thereto. For example, the first ambient light information generation unit 38 may calculate, as the ambient light value N, an average value of pulse count values of a plurality of bins excluding a bin having a pulse count value higher than a predetermined threshold value.

Further, the first ambient light information generation unit 38 may convert the calculated average value into an ambient light value corresponding to the high resolution frequency distribution according to the ratio of the time interval of the high resolution bin to the time interval of the low resolution bin. Specifically, when the time width of the low resolution bin is 10 ns and the time width of the high resolution bin is 1 ns, a value obtained by multiplying the average value calculated as described above by 1/10 can be applied as the ambient light value N in the high resolution frequency distribution.

Next, the operation of the second decoder unit 361 will be described in detail. The second decoder unit 361 receives a signal indicating the start of the frame period from the control unit 31 and starts the operation.

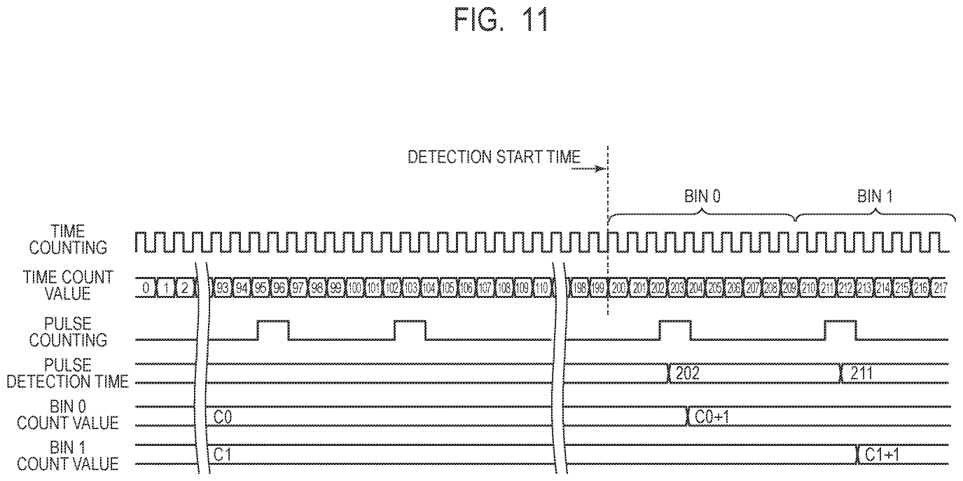

FIG. 11 is a timing chart illustrating the operation of the second decoder unit 361 according to the present embodiment. Since the kinds of signals illustrated in FIG. 11 are the same as those illustrated in FIG. 8, description thereof will be omitted.

FIG. 11 illustrates an example in which the time when the time count value is “200” is the start time of frequency distribution acquisition. In this example, when a photon is incident and a pulse rises in the pulse counting during a period in which the count value is “200” to “209”, the count value of “bin 0” is updated. When a photon is incident and a pulse rises in the pulse counting during a period in which the count value is “210” to “219”, the count value of “bin 1” is updated. The second decoder unit 361 updates the value of “bin 0” from “C0” to “C0+1” in accordance with the pulse inputted at the time when the count value is “202”. Further, the second decoder unit 361 updates the value of “bin 1” from “C1” to “C1+1” in accordance with the pulse inputted when the count value is “211”.

On the other hand, the second decoder unit 361 does not detect pulses outside the acquisition range set by the range determination unit 37. That is, in the example of FIG. 11, although two photons are incident and pulses rise in the pulse counting during a period in which the count value is “0” to “199”, they are not detected.

Next, the operation of the distance calculation unit 363 will be described in detail. The distance calculation unit 363 receives a signal indicating the start of the frame period from the control unit 31 and starts the operation.

The second peak detection unit 364 outputs the peak time information to the reliability calculation unit 365. The peak time information generated by the second peak detection unit 364 may be information indicating a bin having the largest value in the frequency distribution, but is not limited thereto. The peak time information may be information indicating a plurality of bins having a value larger than a predetermined value in the frequency distribution, or may be information indicating a plurality of bins including bins before and after the bin having the largest value.

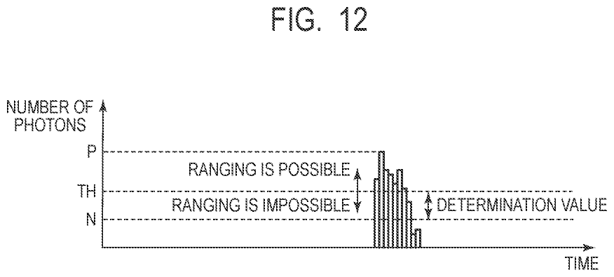

The reliability calculation unit 365 calculates the reliability information corresponding to the time information at the peak based on the high resolution frequency distribution, the ambient light information, and the peak time information. Hereinafter, an example of a method of generating reliability information will be described with reference to FIG. 12. FIG. 12 is a histogram illustrating an example of the high resolution frequency distribution and the ambient light value according to the embodiment. FIG. 12 is a histogram of the high resolution frequency distribution similar to FIG. 5C. FIG. 12 illustrates the ambient light value N, the threshold value TH, and the peak value P.

The threshold value TH is obtained by adding a predetermined determination value to the ambient light value N. When the peak value P is greater than the threshold value TH, since the peak value P is sufficiently higher than the ambient light value N and there is a high possibility that appropriate ranging is performed, the reliability calculation unit 365 outputs a reliability value indicating that ranging is possible as reliability information. When the peak value P is equal to or less than the threshold value TH, since the peak value P is not sufficiently higher than the ambient light value N and the possibility that appropriate ranging is performed is low due to the influence of the ambient light, the reliability calculation unit 365 outputs a reliability value indicating that ranging is impossible as reliability information. Thus, the reliability information may be a binary reliability value indicating whether ranging is possible or impossible. However, the reliability information is not limited thereto, and may be a reliability value obtained by calculating the peak value P of the peak and the ambient light value N using a predetermined calculation formula.

As described above, in the present embodiment, in the ranging device 1 that determines the acquisition range of the high resolution frequency distribution from the low resolution frequency distribution, the ranging device 1 generates ambient light information from the low resolution frequency distribution and generates reliability information from the ambient light information. The number of samples is increased by using not a high resolution frequency distribution having a narrow acquisition range but a low resolution frequency distribution having a wide acquisition range for generating ambient light information. Since ambient light has a property close to random noise, the accuracy of ambient light information is improved by increasing the number of samples. Thus, according to the present embodiment, the ranging device 1 with improved accuracy in calculating the ambient light information and the reliability is provided.

### Second Embodiment

In the first embodiment, the method of generating ambient light information from the low resolution frequency distribution and calculating the reliability information using the ambient light information has been described. However, the ambient light information may be generated from both the low resolution frequency distribution and the high resolution frequency distribution and used for calculating the reliability information. Hereinafter, a second embodiment will be described. Note that the configuration of the ranging device 1 illustrated in the present embodiment is an example, and is not limited to the illustrated configuration. In addition, description of elements common to those of the first embodiment may be omitted or simplified as appropriate.

First, an example in which the configuration of the present embodiment can be more suitably applied will be described. In general, ranging devices that acquire frequency distributions and perform ranging include a ranging device in which the number of photons that can be acquired in one shot is not substantially limited, and a ranging device in which there is an upper limit on the number of photons that can be acquired in one shot. In the latter ranging device, by storing the light reception time in a predetermined number of buffers, it is not necessary to perform processing from reception of light to generation of a frequency distribution in real time, and there is an advantage that processing can be performed by a relatively simple circuit. However, in such a ranging device, when a predetermined number of photons are received and then other photons are further received, the incident time of the later photons is not stored. Therefore, photons of later incident time corresponding to a long distance tend to be missing from the frequency distribution.

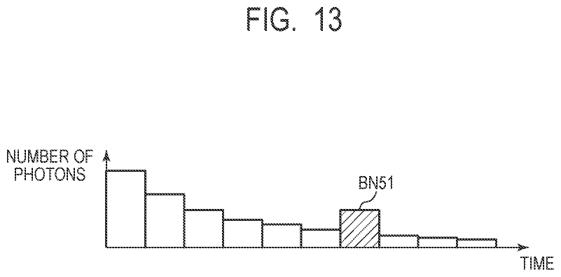

FIG. 13 is a histogram illustrating an example of a low resolution frequency distribution according to the second embodiment. FIG. 13 illustrates an example of a low resolution frequency distribution when there is an upper limit on the number of photons that can be acquired in one shot. As described above, since photons incident at a late time are likely to be missing from the frequency distribution, the histogram of the low resolution frequency distribution tends to have a quadratic curve shape as illustrated in FIG. 13. In this case, since the ambient light varies depending on the position of the bin, the error of the ambient light value may increase in the method of the first embodiment. In the present embodiment, a method of calculating an ambient light value with high accuracy in such a ranging device will be described. The present embodiment is not limited to a ranging device in which there is an upper limit on the number of photons that can be acquired in one shot, but can be widely applied to a ranging device in which the shape of a histogram of frequency distribution has some tendency.

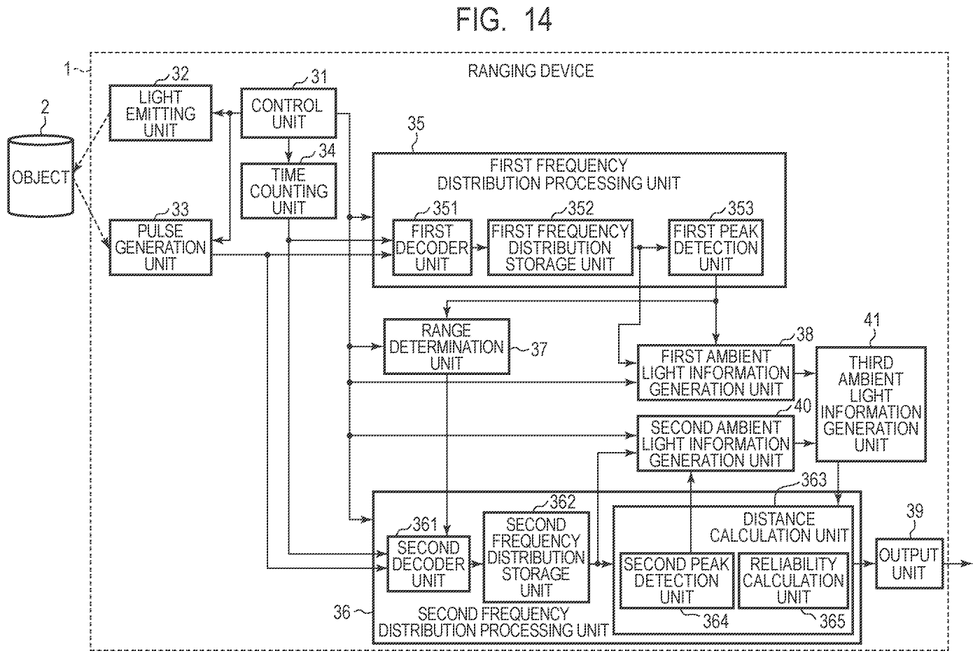

FIG. 14 is a functional block diagram illustrating a schematic configuration example of the ranging device 1 according to the present embodiment. In addition to the configuration illustrated in FIG. 2, the ranging device 1 of the present embodiment further includes a second ambient light information generation unit 40 and a third ambient light information generation unit 41.

The first ambient light information generation unit 38 calculates first ambient light information based on the frequency distribution stored in the first frequency distribution storage unit 352 and the peak time information calculated by the first peak detection unit 353. The second ambient light information generation unit 40 calculates second ambient light information based on the frequency distribution stored in the second frequency distribution storage unit 362 and the peak time information calculated by the second peak detection unit 364. The third ambient light information generation unit 41 compares the first ambient light information and the second ambient light information, generates third ambient light information based on them, and outputs the third ambient light information to the distance calculation unit 363.

When there is some tendency in the histogram of the frequency distribution, it is desirable to use the second ambient light information including the ambient light at a time close to the peak for the calculation of the reliability information. However, since the acquisition range of the high resolution frequency distribution is limited, an error is likely to occur in the second ambient light information. Therefore, the third ambient light information generation unit 41 compares the first ambient light information and the second ambient light information, and when it is determined that the second ambient light information is an abnormal value, the third ambient light information generation unit 41 can generate the third ambient light information in which the second ambient light information is corrected or substituted by the first ambient light information. The reliability calculation unit 365 calculates the reliability information using the third ambient light information in the same manner as in the first embodiment.

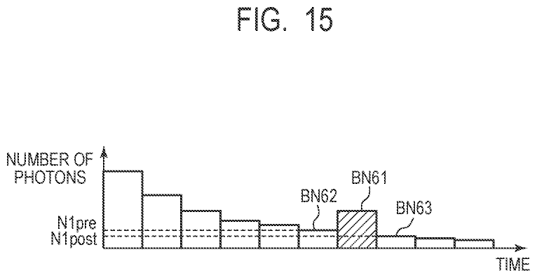

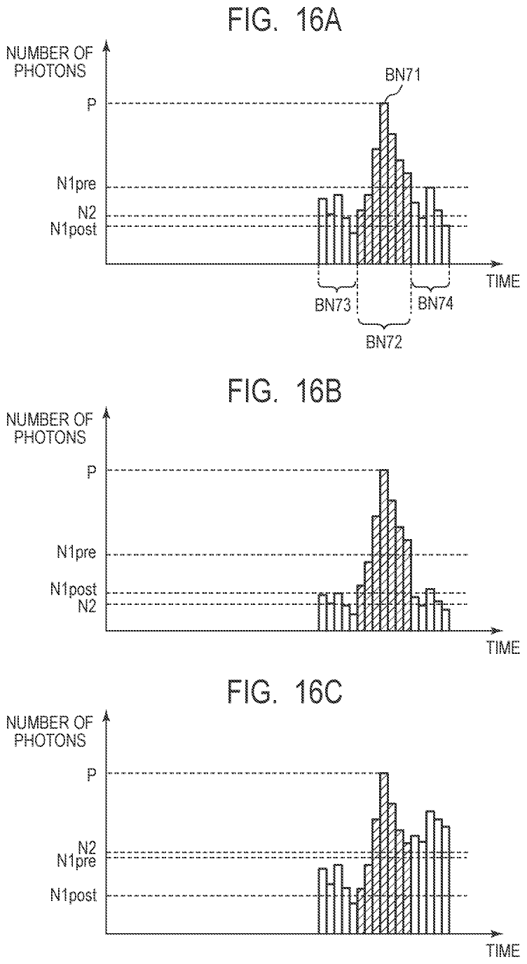

An example of generating ambient light information from a low resolution frequency distribution and a high resolution frequency distribution will be described below with reference to FIGS. 15 to 16C. FIG. 15 is a histogram illustrating an example of a low resolution frequency distribution and an ambient light value according to the present embodiment. FIGS. 16A to 16C are histograms illustrating examples of high resolution frequency distributions and ambient light values according to the present embodiment.

In the low resolution frequency distribution of FIG. 15, a bin BN61 is a bin including a pulse count value based on reflected light. The first ambient light information generation unit 38 extracts an ambient light value N1pre (first ambient light value) which is a pulse count value of a bin BN62 immediately before the bin BN61 and an ambient light value N1post (second ambient light value) which is a pulse count value of a bin BN63 immediately after the bin BN61. Then, the first ambient light information generation unit 38 outputs the ambient light values N1pre and N1post to the third ambient light information generation unit 41 as the first ambient light information.

A method of determining a bin including a pulse count value based on reflected light from a frequency distribution of a quadratic curve shape as illustrated in FIG. 15 is not particularly limited. As an example of the method, for example, it is determined whether or not each bin includes a pulse count value of reflected light based on whether or not a pulse count value of a target bin exceeds a threshold value that is set for each bin in consideration of ambient illuminance. Another example is to determine whether each bin includes a pulse count value based on reflected light based on a difference between a pulse count value of a target bin and a pulse count value of a bin before or after the target bin. Still another example is to determine whether each bin includes a pulse count value by reflected light based on a difference between a pulse count value of a target bin and an average value of pulse count values of bins before and after the target bin.

FIGS. 16A to 16C illustrate high resolution frequency distributions obtained corresponding to the time range of the bin BN61 illustrated in FIG. 15. FIGS. 16A to 16C illustrate three examples in which pulse count values are different from each other.

First, the operation of the second ambient light information generation unit 40 will be described with reference to FIG. 16A. The second ambient light information generation unit 40 generates the second ambient light information from pulse count values of a plurality of bins BN73 and BN74 excluding a predetermined number of bins BN72 centered on a bin BN71 that corresponds to a peak detected by the second peak detection unit 364. An ambient light value N2 (third ambient light value) included in the second ambient light information may be an average value of pulse count values of a plurality of bins BN73 and BN74. Thus, bins BN72 that may include the influence of the reflected light is excluded from the second ambient light information. The number of bins BN72 is determined in consideration of, for example, a pulse width of the light emitted from the light emitting unit 32, assumed moving speed of the object 2, and the like. In the example of FIG. 16A, the BN72, which is to be excluded, includes three bins before and after the peak bin BN71. This operation is the same in the case of FIGS. 16B and 16C.

The third ambient light information generation unit 41 compares the ambient light value N1pre with the ambient light value N2, compares the ambient light value N1post with the ambient light value N2, and determines the third ambient light information based on these results. A method of determining the third ambient light information in the three examples of FIGS. 16A to 16C will be described below.

FIG. 16A illustrates an example in which the ambient light value N2 is less than the ambient light value N1pre and the ambient light value N2 is greater than the ambient light value N1post. This is an example in which the ambient light value N2 is normally obtained. In this case, the third ambient light information generation unit 41 outputs the value of the ambient light value N2 as it is as the third ambient light information.

FIG. 16B illustrates an example in which the ambient light value N2 is less than the ambient light value N1pre and the ambient light value N1post. In this example, there is a possibility that an error occurs because the number of bins used for calculating the ambient light value N2 is small. In this case, the third ambient light information generation unit 41 outputs the ambient light value N1post as the third ambient light information. Alternatively, the third ambient light information generation unit 41 may output an average value of the ambient light value N1post and the ambient light value N2 as the third ambient light information.

FIG. 16C illustrates an example in which the ambient light value N2 is greater than the ambient light value N1pre and the ambient light value N1post. In this example, in addition to the possibility that an error occurs because the number of bins used for calculating the ambient light value N2 is small, the bin BN61 in FIG. 15 may include pulse count values due to reflected light from a plurality of objects 2. When the bin BN61 includes a pulse count value based on reflected light from the plurality of objects 2, it is difficult to calculate ambient light values excluding all bins including reflected light. That is, in this example, the ambient light value N2 is likely to include a pulse count value due to reflected light, and cannot be regarded as an appropriate ambient light value. In this case, the third ambient light information generation unit 41 outputs the ambient light value N1pre as the third ambient light information. Alternatively, the third ambient light information generation unit 41 may output an average value of the ambient light value N1pre and the ambient light value N1post as the third ambient light information.

Note that the method of calculating the ambient light values N1pre and N1post in the present embodiment is not limited to the above example, and various methods can be applied. The ambient light value N1pre may be calculated from a plurality of bins before the bin BN61 that is a peak, or may be calculated from all bins before the bin BN61. Further, the ambient light value N1post may be calculated from a plurality of bins after the bin BN61 that is a peak, or may be calculated from all bins after the bin BN61. For example, the ambient light value N1post may be greater than the ambient light value N1pre due to an error. In such a case, by calculating the ambient light values N1pre and N1post from a plurality of bins, it is possible to increase the number of samples of the first ambient light information and improve the accuracy thereof.

The method of calculating the ambient light value N2 in the present embodiment is not limited to the above example, and various methods can be applied. The ambient light value N2 may be an average value of the remaining bins further excluding the upper several bins, or may be an average value of the remaining bins further excluding the upper and lower several bins. For example, the second ambient light information generation unit 40 may calculate, as the ambient light value N2, an average value of pulse count values of a plurality of bins excluding a bin having a pulse count value higher than a predetermined threshold value.

Further, the comparison operation in the third ambient light information generation unit 41 is not limited to the above. The third ambient light information generation unit 41 may perform comparison by adding an offset to at least one of the ambient light value N1pre or N1post and the ambient light value N2. When an average value is used in the calculation of the third ambient light information, a weighted average value weighted by a predetermined weight may be used, or an offset may be added to the average value.

As described above, in the present embodiment, both the low resolution frequency distribution and the high resolution frequency distribution are used for calculating the reliability information. As a result, according to the present embodiment, the ranging device 1 with improved accuracy in calculating even when the shape of the histogram of the frequency distribution has some tendency is provided.

### Third Embodiment

In the second embodiment, when the ambient light value N2 is greater than the ambient light value N1pre and the ambient light value N1post, the third ambient light information generation unit 41 generates the third ambient light information based on at least one of the ambient light value N1pre and the ambient light value N1post. On the other hand, in the third embodiment, when the ambient light value N2 is greater than the ambient light value N1pre, the third ambient light information generation unit 41 outputs, to the distance calculation unit 363, peak state information indicating a possibility that a plurality of peaks exist in addition to the third ambient light information. In the description of the present embodiment, elements common to those of the first embodiment or the second embodiment may be appropriately omitted or simplified.

The distance calculation unit 363 controls the second peak detection unit 364 so that the second peak detection unit 364 redetects a peak when the second peak detection unit 364 receives the peak state information indicating the possibility that the plurality of peaks exist. The second peak detection unit 364 may detect each of the plurality of peaks, or may detect a peak corresponding to the shortest distance among the plurality of peaks.

Alternatively, the distance calculation unit 363 controls the reliability calculation unit 365 to calculate the reliability information based on the peak state information when the distance calculation unit 363 receives the peak state information indicating the possibility that the plurality of peaks exist. The reliability calculation unit 365 may output the peak state information to the output unit 39 as it is. When the second peak detection unit 364 detects a plurality of peaks, the reliability calculation unit 365 may calculate the reliability information for each of the plurality of peaks.

As described above, in the present embodiment, when the ambient light value N2 is greater than the ambient light value N1pre, the peak state information indicating the possibility that the plurality of peaks exist is output in addition to the third ambient light information. As a result, according to the present embodiment, the ranging device 1 with improved accuracy in calculating the reliability even when the shape of the histogram of the frequency distribution has some tendency is provided.

### Fourth Embodiment

In the present embodiment, a specific configuration example of a photoelectric conversion device that includes an avalanche photodiode and that can be applied to the ranging device 1 according to the first to third embodiments will be described. The configuration example of the present embodiment is an example, and the photoelectric conversion device applicable to the ranging device 1 is not limited thereto.

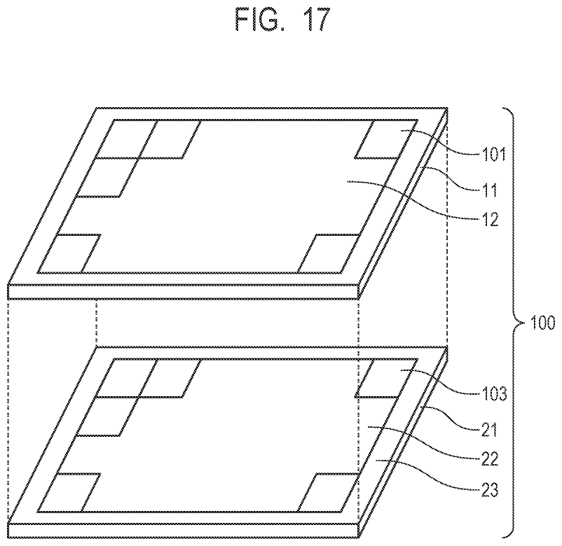

FIG. 17 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

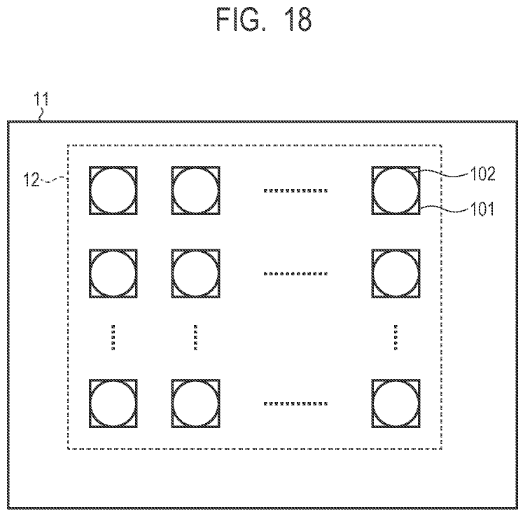

FIG. 18 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

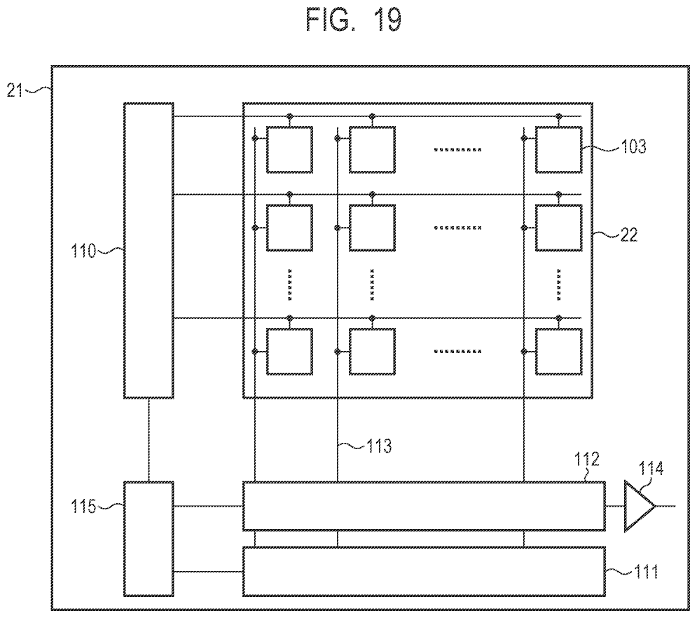

FIG. 19 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 18 and the plurality of pixel signal processing units 103 illustrated in FIG. 19 are electrically connected to each other via connection wirings provided for each pixels 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixels 101 is processed by the pixel signal processing unit 103. The pixel signal processing unit 103 acquires and holds a digital signal having a plurality of bits by counting the number of pulses output from the APD included in the photoelectric conversion unit 102.

It is not always necessary to provide one pixel signal processing unit 103 for each of the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided one by one in all the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

As illustrated in FIGS. 18 and 19, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 19. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

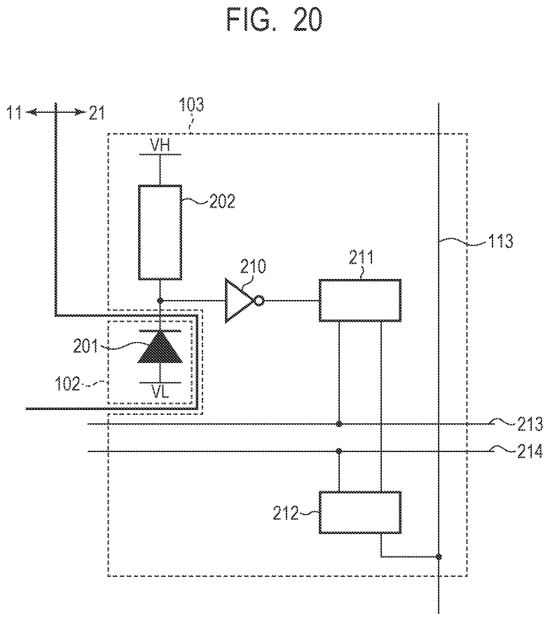

FIG. 20 is a schematic block diagram illustrating a configuration example of one pixel of the photoelectric conversion unit 102 and the pixel signal processing unit 103 according to the present embodiment. FIG. 20 schematically illustrates a more specific configuration example including a connection relationship between the photoelectric conversion unit 102 arranged in the sensor substrate 11 and the pixel signal processing unit 103 arranged in the circuit substrate 21. In FIG. 20, driving lines between the vertical scanning circuit 110 and the pixel signal processing unit 103 in FIG. 19 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212. The pixel signal processing unit 103 may include at least one of the waveform shaping unit 210, the counter circuit 211, and the selection circuit 212.

The APD 201 generates charge pairs corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. For example, an inverter circuit is used as the waveform shaping unit 210. Although FIG. 20 illustrates an example in which one inverter is used as the waveform shaping unit 210, the waveform shaping unit 210 may be a circuit in which a plurality of inverters are connected in series, or may be another circuit having a waveform shaping effect.

The counter circuit 211 counts the pulse signals output from the waveform shaping unit 210, and holds a digital signal indicating the count value. When a control signal is supplied from the vertical scanning circuit 110 through the driving line 213, the counter circuit 211 resets the held signal.

The selection circuit 212 is supplied with a control signal from the vertical scanning circuit 110 illustrated in FIG. 19 through the driving line 214 illustrated in FIG. 20. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 20, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

FIG. 20 illustrates a configuration example using the counter circuit 211. However, instead of the counter circuit 211, a time-to-digital converter (TDC) and a memory may be used to acquire a timing at which a pulse is detected. In this case, the generation timing of the pulsed signal output from the waveform shaping unit 210 is converted into a digital signal by the TDC. In this case, a control signal (reference signal) can be supplied from the vertical scanning circuit 110 illustrated in FIG. 19 to the TDC via the driving line. The TDC acquires, as a digital signal, a signal indicating a relative time of input timing of a pulse with respect to the control signal.

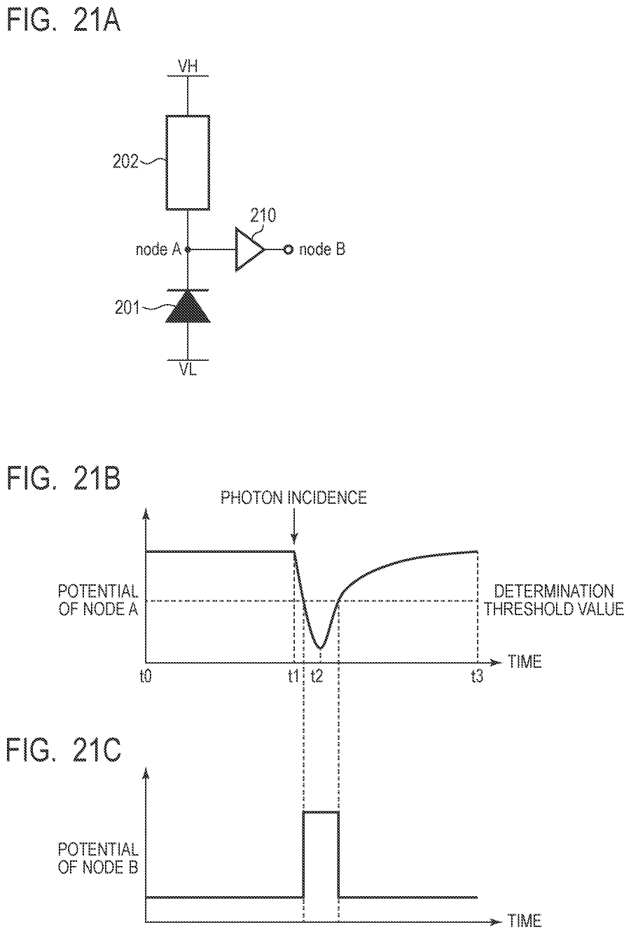

FIGS. 21A, 21B, and 21C are diagrams illustrating an operation of the APD 201 according to the present embodiment. FIG. 21A is a diagram illustrating the APD 201, the quenching element 202, and the waveform shaping unit 210 in FIG. 20. As illustrated in FIG. 21A, the connection node of the APD 201, the quenching element 202, and the input terminal of the waveform shaping unit 210 is referred to as node A. Further, as illustrated in FIG. 21A, an output side of the waveform shaping unit 210 is referred to as node B.

FIG. 21B is a graph illustrating a temporal change in the potential of node A in FIG. 21A. FIG. 21C is a graph illustrating a temporal change in the potential of node B in FIG. 21A. During a period from time t0 to time t1, the voltage VH-VL is applied to the APD 201 in FIG. 21A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

According to the present embodiment, a photoelectric conversion device using an avalanche photodiode which can be applied to the ranging device 1 of the first to third embodiments is provided.

### Fifth Embodiment

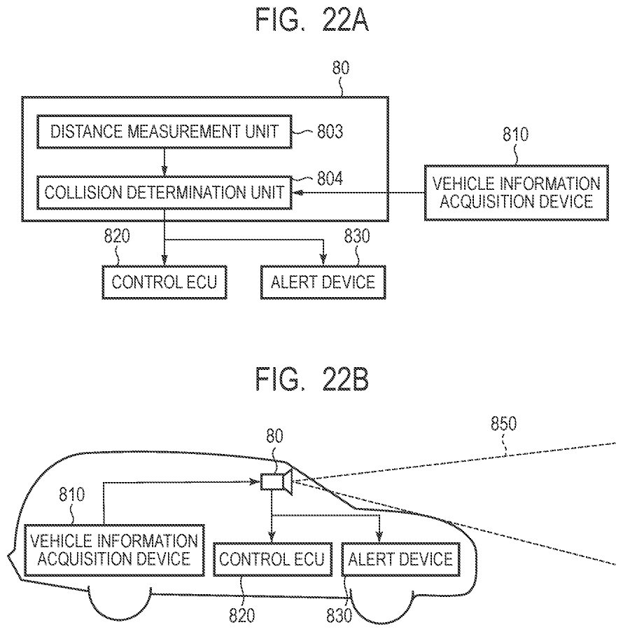

FIGS. 22A and 22B are block diagrams of equipment relating to an in-vehicle ranging device according to the present embodiment. Equipment 80 includes a distance measurement unit 803, which is an example of the ranging device 1 of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 22B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present invention. Although the above-described embodiments disclose an example in which the reliability information is calculated based on the ambient light information and the reliability information is output to the outside of the ranging device 1, it is not essential to calculate the reliability information. For example, the ranging device 1 may output the ambient light information to the outside as it is.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-166893, filed Oct. 18, 2022, which is hereby incorporated by reference herein in its entirety.

What is claimed is:

1. A ranging device comprising:
a time counting unit configured to generate a time count value;
a pulse generation unit configured to generate a signal including a pulse based on incident light;
a first decoder unit configured to generate a first frequency distribution having a first class width based on the time count value and the number of pulses;
a first peak detection unit configured to determine first time information indicating a time corresponding to a first peak of the number of pulses based on the first frequency distribution;
a second decoder unit configured to generate a second frequency distribution having a second class width narrower than the first class width based on the time count value and the number of pulses;
a range determination unit configured to determine a range of the time count value at which the second frequency distribution is to be acquired based on the first time information;
a first ambient light information generation unit configured to generate first ambient light information based on the first frequency distribution; and
a distance calculation unit configured to calculate distance information based on the second frequency distribution.

2. The ranging device according to claim 1, wherein the distance calculation unit further calculates reliability information indicating reliability of ranging based on the second frequency distribution and the first ambient light information.

3. The ranging device according to claim 1 further comprising:
a light emitting unit configured to emit light to an object; and
a control unit configured to synchronously control a timing at which the light emitting unit emits light and a timing at which the time counting unit starts time counting.

4. The ranging device according to claim 1, wherein the first ambient light information generation unit generates the first ambient light information based on a number of pulses of a part of classes in the first frequency distribution excluding at least a class corresponding to the first peak.

5. The ranging device according to claim 1, wherein the distance information is calculated based on a second peak of the number of pulses of the second frequency distribution.

6. The ranging device according to claim 5, wherein the distance calculation unit further calculates reliability information indicating whether or not the number of pulses of the second peak exceeds a threshold value that is set based on the first ambient light information.

7. The ranging device according to claim 5, wherein the distance calculation unit further calculates reliability information including a reliability value calculated from the number of pulses of the second peak and the first ambient light information.

8. The ranging device according to claim 1 further comprising:
a second ambient light information generation unit configured to generate second ambient light information based on the second frequency distribution; and
a third ambient light information generation unit configured to generate third ambient light information based on the first ambient light information and the second ambient light information.

9. The ranging device according to claim 8, wherein the distance calculation unit calculates reliability information indicating reliability of the distance information and ranging based on the second frequency distribution and the third ambient light information.

10. The ranging device according to claim 8, wherein the first ambient light information generation unit generates the first ambient light information based on the number of pulses of a class adjacent to a class corresponding to the first peak in the first frequency distribution.

11. The ranging device according to claim 8,
wherein the first ambient light information includes a first ambient light value and a second ambient light value, each based on the number of pulses of corresponding one of two classes adjacent to a class corresponding to the first peak in the first frequency distribution,
wherein the second ambient light information includes a third ambient light value based on a number of pulses of a part of classes in the second frequency distribution excluding at least one class, and
wherein the third ambient light information generation unit generates the third ambient light information based on the first ambient light value, the second ambient light value, and the third ambient light value.

12. The ranging device according to claim 11, wherein when the third ambient light value is greater than the first ambient light value and the second ambient light value, the third ambient light information generation unit outputs the greater one of the first ambient light value and the second ambient light value as the third ambient light information.

13. The ranging device according to claim 11, wherein when the third ambient light value is greater than the first ambient light value and the second ambient light value, the third ambient light information generation unit outputs an average value of the first ambient light value and the second ambient light value as the third ambient light information.

14. The ranging device according to claim 11, wherein when the third ambient light value is greater than the first ambient light value and the second ambient light value, the third ambient light information generation unit further outputs peak state information indicating a possibility that a plurality of peaks are present in the second frequency distribution.

15. The ranging device according to claim 14, wherein the distance calculation unit calculates the distance information for each of the plurality of peaks based on the peak state information.

16. The ranging device according to claim 14, wherein the distance calculation unit calculates the distance information for a peak corresponding to the shortest distance among the plurality of peaks based on the peak state information.

17. The ranging device according to claim 11, wherein when the third ambient light value is a value between the first ambient light value and the second ambient light value, the third ambient light information generation unit outputs the third ambient light value as the third ambient light information.

18. The ranging device according to claim 11, wherein when the third ambient light value is less than the first ambient light value and the second ambient light value, the third ambient light information generation unit outputs the less one of the first ambient light value and the second ambient light value as the third ambient light information.

19. The ranging device according to claim 11, wherein when the third ambient light value is less than the first ambient light value and the second ambient light value, the third ambient light information generation unit outputs an average value of the third ambient light value and the less one of the first ambient light value and the second ambient light value as the third ambient light information.

20. The ranging device according to claim 8, wherein the second ambient light information generation unit generates the second ambient light information based on a number of pulses of a part of classes in the second frequency distribution excluding a class including a second peak and a class adjacent to the second peak.

21. The ranging device according to claim 1, wherein the generation of the first frequency distribution by the first decoder unit and the generation of the second frequency distribution by the second decoder unit are performed in parallel.

22. A movable body comprising:
the ranging device according to claim 1; and
a movable body control unit configured to control the movable body based on distance information acquired by the ranging device.
